(19) United States
(12) Patent Application Publication
(10) Pub. No.: US 2011/0055108 A1
(43) Pub. Date: Mar. 3, 2011

(54) REFINING PROCESSES USING VIRTUAL-WORLDS TO CAPTURE PROCESS DATA AND REPLAYING FOR ANALYSIS AND REVIEW

(75) Inventors: Mihnea Galeteanu, Markham (CA); Paul J. Pacholski, Markham (CA)

(73) Assignee: INTERNATIONAL BUSINESS MACHINES CORPORATION, Armonk, NY (US)

(21) Appl. No.: 12/868,950

(22) Filed: Aug. 26, 2010

(30) Foreign Application Priority Data
Aug. 28, 2009 (CA) 2675695

(51) Int. Cl. G06Q 10/00

(52) U.S. Cl. 705/348

(57) ABSTRACT

A method for using virtual worlds to model and refine business processes is disclosed herein. In one embodiment, such a method may include providing a virtual-world work environment corresponding to a real-world work environment. The method may further include enabling multiple users to log into the virtual-world work environment and act as participants in the virtual-world work environment simulation. Once logged in, the participants may act out a real-world business process in the virtual-world work environment. The actions and communications of the participants may be captured while the participants act out the real-world business process. These actions and communications may be recorded in a computer file that may be exported into a business process modeling application. The business process modeling application may be used by a process analyst to analyze and/or refine the business process. A corresponding apparatus and computer program product are also disclosed and claimed herein.

### FIELD OF THE INVENTION

This invention relates to using virtual worlds to model and refine business processes, and more particularly to apparatus and methods for simulating, iteratively improving, and replaying updated business processes using virtual worlds.

### BACKGROUND OF THE INVENTION

A business process is a collection of related, structured activities or tasks that produce a service or product for one or more customers. Business process modeling (BPM), on the other hand, is the activity of simulating and representing business processes so that they can be analyzed and improved. Various tools have been developed to model business processes. These tools provide business analysts and managers the ability to model their business processes, implement and execute business process models, and refine business process models.

One of the difficulties of modeling real-life business processes is that almost every modeling tool requires a user to simplify complex business processes into what are essentially flow charts. Creating these flow charts often originates with one person, a process analyst, tracing the business process through the organization by conducting interviews with participants involved in executing the business process. The process analyst may then refine the business process to improve efficiency, save money, or provide other benefits to the organization.

Once the business process has been captured and refined to achieve desired improvements, the business process may be simulated either on paper or by feeding data into a simulation engine to generate a report. The report may be presented to upper-level management which may ultimately decide whether the improvement suggestions should be implemented. By this point, a significant amount of time and money has been spent at various levels of the organization. This time and money will be lost if the changes are not implemented or the process fails upon implementation.

### SUMMARY

Consistent with the foregoing, one aspect of the present invention is a method, apparatus and computer program product for using virtual worlds to model business processes is disclosed herein. In one embodiment, such a method may include providing a virtual-world work environment corresponding to a real-world work environment. The method may further include enabling multiple users to log into the virtual-world work environment and act as participants in the virtual-world work environment. Once logged in, the participants may act out a real-world business process in the virtual-world work environment. The actions and communications of the participants may be captured while the participants act out the real-world business process. These actions and communications may be recorded in a computer file that may be exported into a business process modeling application. The business process modeling application may be used by a process analyst to analyze and/or refine the business process.

One advantage of the present invention is it can enable the business to save both time and money when refining and simulating business processes. In particular, some embodiments of the invention are desirable because they save both time and money for the process analyst, the enterprise, and the participants involved in modeling a business process. Further, embodiments of the present invention are useful to effectively educate upper-level management as well as participants in the business process about improvements or refinements to the process. These and other features and advantages of the invention will become more fully apparent from the following description and appended claims.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a system using a virtual world to capture a real-world business process;

FIG. 2 is a high-level block diagram showing how the system of FIG. 1 can be used to simulate a refined business process;

FIG. 3 shows one example of a business process as it might be represented inside a business process modeling application;

FIG. 4 shows the business process of FIG. 3 after it has been refined by a process analyst; and

FIG. 5 is a high-level block diagram showing various modules that may be used to implement the methods of FIGS. 1 and 2.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer program product. Furthermore, certain aspects of the invention may take the form of a hardware embodiment, a software embodiment (including firmware, resident software, micro-code, etc.) configured to operate hardware, or an embodiment combining software and hardware aspects that may all generally be referred to herein as a “module” or “system.” Furthermore, certain aspects of the invention may take the form of a computer program product embodied in any tangible medium of expression having computer-usable program code stored in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device. In the context of this document, a computer-usable or computer-readable medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described below with reference to flowchart illustrations and/or block diagrams of processes, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instructions which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

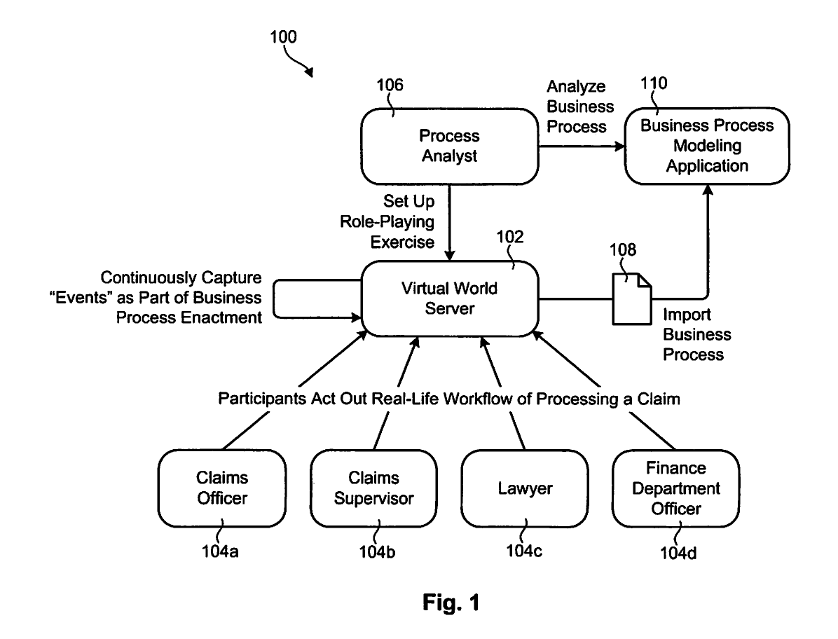

Referring to FIG. 1, one example of a system 100 using a virtual world to capture a real-world business process is illustrated. In this example, the system 100 includes a server 102 to provide access to a virtual world. The virtual world server 102 may enable a process analyst 106 to create a virtual environment within the virtual world roughly corresponding to a real-world work environment. The process analyst may establish a role-playing exercise in the virtual world environment that mimics a real-life business process. The process analyst may then invite one or more real-world participants to participate in the exercise. In this example, the role-playing exercise is that of processing an insurance claim and the participants are a claims officer 104a, claims supervisor 104b, lawyer 104c, and finance department officer 104d, although these participants are only provided as examples. Indeed, the system 100 may be configured to create role-playing exercises for a wide variety of different business processes and with a wide variety of different participants.

Once the participants are invited to participate in the role-playing exercise, the participants are allowed to log into the virtual world server 102 from client machines 104 and assume avatars in the virtual world. The participants are then asked to act out the real-world business process in the virtual world. When acting out the real-world business process, the participants will try to navigate through the virtual environment and interact with other participants in much the same way they would act in a real-world environment in order to complete the assignment or goal of the role-playing exercise.

As the participants act out the real-world business process, the virtual world server 102 tracks and captures each of the actions (e.g., notations, movements, handoffs, interactions, etc.) and communications (e.g., chats, emails, letters, phone calls, etc.) of the participants in order to document the business process. The virtual world server 102 may also capture information such as the identities of the participants involved in the actions or communications, the time and/or date the actions or communications occurred, and the locations and order in which the actions or communications occurred. All of this information may be recorded in a computer file 108, such as an XML file, that may be exported from the virtual world server 102 once the role-playing exercise is complete. In certain embodiments, the computer file 108 may be imported into a business process modeling application 110 (e.g., the IBM Websphere Business Modeler Advanced business process modeling and analysis tool, available from IBM Corporation of Armonk, N.Y., or other analogous or comparable application 110) where the business process may be displayed (as flow charts and/or other diagrams), as well as further analyzed and/or refined.

By using a virtual world (as opposed to observations in the real world) to capture the activities and tasks of a business process, the process analyst may be able to reduce the time, cost, and intrusiveness associated with documenting a business process. The process analyst may also be better able to capture and document virtual events, such as emails or other computing-based actions or processes, that are increasingly prevalent in today's organizations. Thus, a virtual world may be an effective tool for capturing real-world business processes.

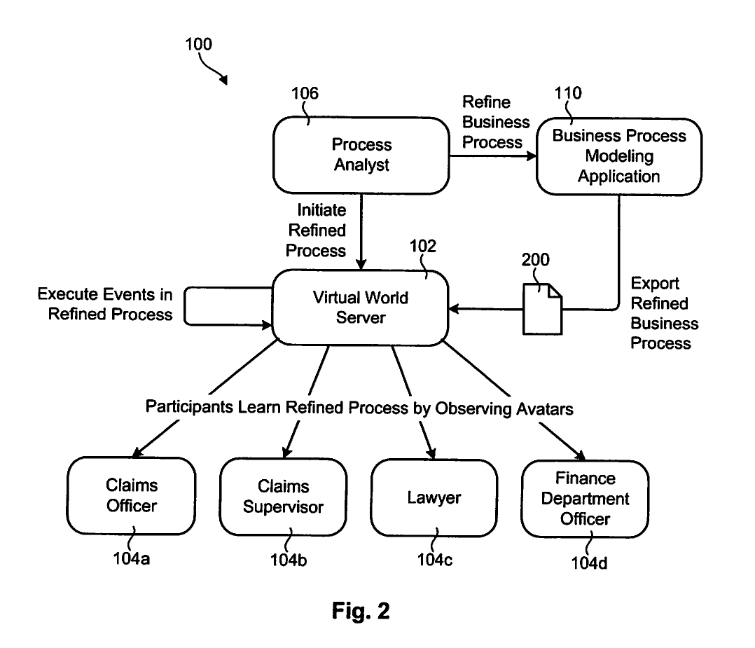

Referring to FIG. 2, the virtual world server 102, in addition to capturing real-world business processes, may also be used to simulate a refined business process. For example, once changes have been made to a business process in a business process modeling application 110, the refined business process may be exported from the application 110 to the virtual world server 102. In certain embodiments, the refined business process may include a series of modified actions and/or communications that are stored in a computer file 200, such as an XML file 200. This computer file 200 may be imported into the virtual world server 102.

Once imported, the virtual world server 102 may perform the actions and communications in the refined business process in the order they are presented in the computer file 200. In certain embodiments, the virtual world server 102 may control the avatars of the various participants in the business process to show their refined actions and/or communications. If desired, the participants may log into the virtual world server 102 from their respective client machines 104 to observe the refined actions and/or communications. The virtual world server 102 may also provide an effective tool for upper-level management to observe the refined business process so that it can determine if the process should be implemented. Thus, the virtual world server 102 may provide an effective tool for educating participants about a refined business process as well as educate upper-level management about the features and benefits of a refined business process.

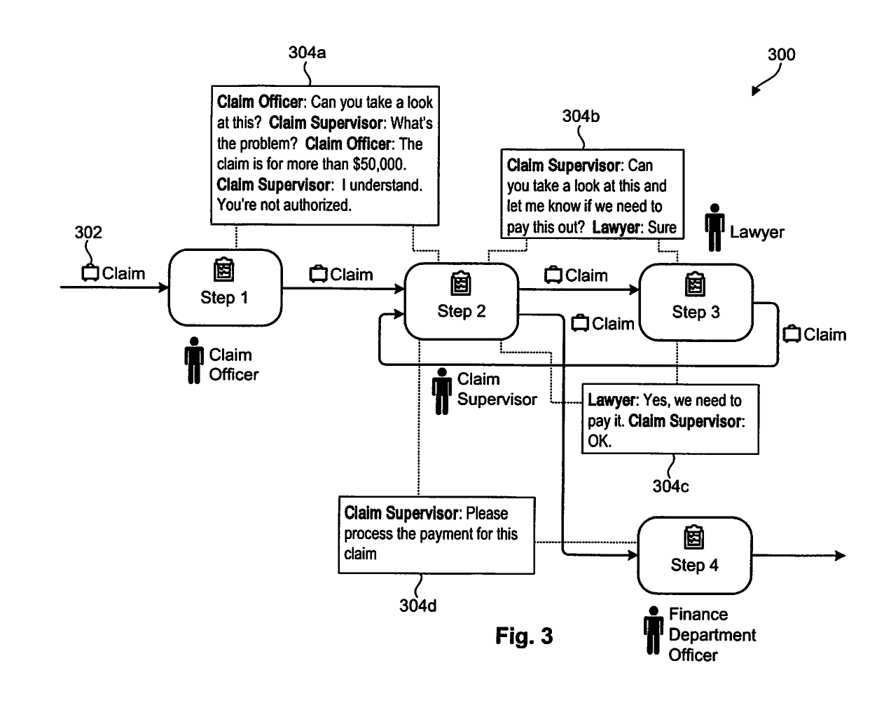

Referring to FIG. 3, one example of a business process 300 as it might appear inside a business process modeling application 110 is illustrated. This business process 300 shows one example of what may have occurred during the role-playing exercise described above. In this example, the captured business process 300 includes a series of steps for processing an insurance claim. Each step was performed by a participant (e.g., a claim officer, claim supervisor, lawyer, and finance department officer) within the organization. As shown in step 1, the claim officer initially received and evaluated the claim 302. In this example, the claim officer transferred the claim 302 to a claim supervisor because the claim officer was not authorized to process claims exceeding $50,000. A dialog box 304a documents the communication between the claim officer and the claim supervisor upon transferring the claim.

Upon receiving the claim, the claim supervisor evaluated the claim (step 2) and, as a result of the evaluation, transferred the claim to a lawyer to determine if the insurance company was legally required to pay the claim. A dialog box 304b documents the communication that occurred between the claim supervisor and the lawyer when this handoff occurred. After examining the applicable law, the insurance contract, and/or the facts of the case (step 3), the lawyer determined that the claim needed to be paid. The lawyer then transferred the claim back to the claim supervisor and notified the claim supervisor that the claim needed to be paid. A dialog box 304c documents the communication between the lawyer and the claim supervisor when the claim is handed back. The claim supervisor then reevaluated the claim (step 2) and passed the claim to the finance department officer. The finance department officer then paid the claim (step 4). A dialog box 304d documents the communication between the claim supervisor and the finance department officer.

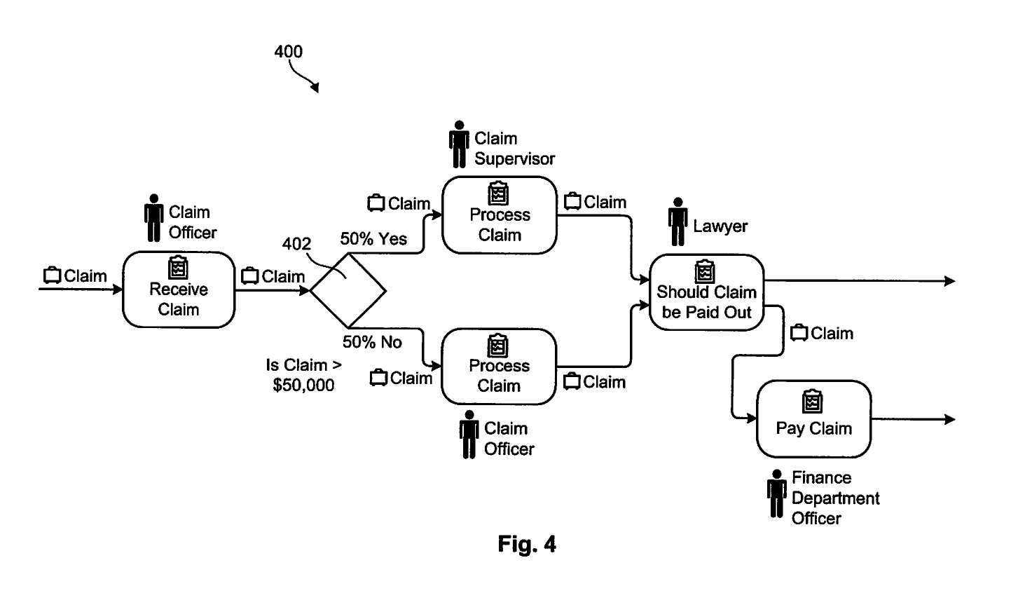

Referring to FIG. 4, once the business process shown in FIG. 3 is generated, the process analyst may analyze and refine the process. FIG. 4 shows one example of the business process 300 after it has been refined, referred to herein as a “refined business process” 400. Like the original business process 300, the refined business process 400 includes a series of steps and documents the participants that perform each of the steps. As shown, the refined business process 400 includes a decision node 402 that indicates that the process can take one of several paths depending on the outcome of the decision. In this example, the decision node 402 decides whether the claim amount is greater than $50,000. The claim officer will process the claim if the claim amount is equal to or less than $50,000. The claim supervisor will process the claim if the claim amount is more than $50,000. Where a decision node 402 is present, each path that extends from the decision node 402 may include the probability that the path will be followed when traversing the decision node 402. These probabilities are important when trying to simulate the process 400 and determine where bottlenecks exist in the process 400.

The refined business process 400 is also different from the original business process 300 because it eliminates a step. As shown in FIG. 3, the lawyer passed the claim back to the claim supervisor once he or she performed his legal evaluation. The claim supervisor then passed the claim to the finance department officer for payment. In the refined business process 400, a step is eliminated by allowing the lawyer to pass the claim directly to the finance department officer once the legal analysis has been performed. This may improve the process 300 and make it more efficient.

Once the business process 300 has been analyzed and refined, the refined business process 400 may be imported into the virtual world server 102 and simulated thereon. In certain embodiments, the virtual world server 102 may control the avatars associated with the various participants to show their refined actions and/or communications. This simulation may be used to educate the participants or upper-level management about the refined business process.

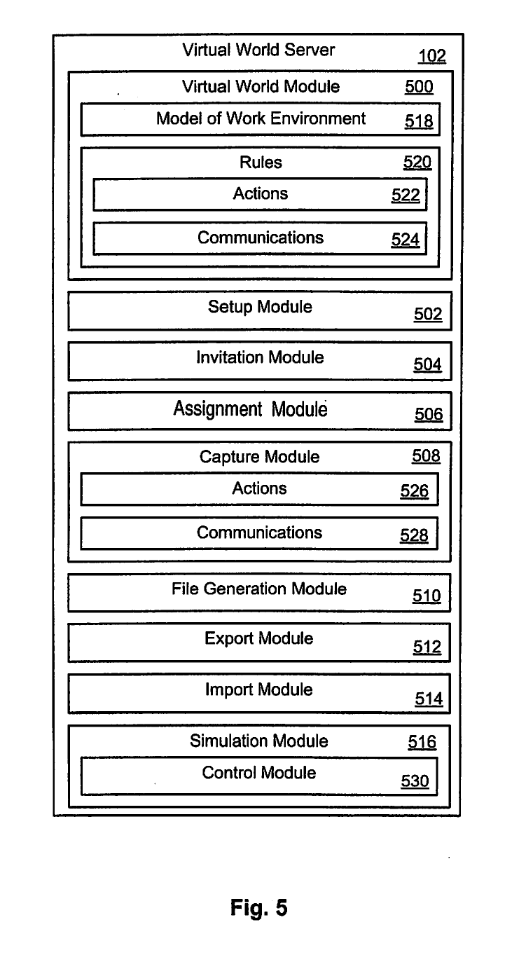

Referring to FIG. 5, at a very high level, a virtual world server 102 may include one or more modules to implement the functionality described in FIGS. 1 and 2. These modules may be embodied in hardware, software configured to operate hardware, firmware configured to operate hardware, or a combination thereof. In selected embodiments, these modules may include one or more of a virtual world module 500, a setup module 502, an invitation module 504, an assignment module 506, a capture module 508, a file generation module 510, an export module 512, an import module 514, and a simulation module 516.

A virtual world module 500 may be used to provide access to a virtual world, and more specifically a virtual work environment. To provide this access, the virtual world module 500 may generate and/or store a model 518, such as a 2D or 3D model 518, of the real-life work environment. Among other definitions, the model 518 may define or describe the avatars that can inhabit and navigate the virtual work environment. The virtual world module 500 may also include rules 520 to govern the virtual work environment. These rules 520 may define what actions 522 are possible within the virtual work environment as well as methods for communicating (e.g., text, voice, sounds, etc.) within the virtual work environment. The virtual world module 500 may include any other features needed to successfully generate the virtual work environment.

An assignment module 502 may allow a process analyst to establish a virtual work environment and set up a role-playing exercise within the virtual work environment. When creating this role-playing exercise, the process analyst may, much like a real-world supervisor, establish a project in the virtual work environment that corresponds to an assignment in a real-world work environment. For example, if the organization is an insurance company, the project may be to process an insurance claim. An invitation module 504 may be used to invite one or more real-world users to participate in the simulation. For example, the invitation module 504 may send an email or other communication to each of the potential participants and ask them to join.

Once the participants receive an invitation, a participation module 506 may assign one or more participants to complete the project and otherwise participate in the virtual work environment. In certain embodiments, a participant may join the project by logging into the virtual world server 102 and choosing an avatar that represents him or her. The participant may then act out a real-world business process in the virtual world in an attempt to complete the project. As the participants act out the real-world business process, a capture module 508 may capture the participants' actions 526 and communications 528.

Once a project has been completed (either successfully or unsuccessfully), a file generation module 510 may generate a computer file that records the actions and communications. This computer file may be exported into a business process modeling application where the business process may be analyzed and/or refined. The business process modeling application may then generate a computer file containing the refined business process or modify an existing computer file such that it contains the refined business process. This computer file may be imported into the virtual world server 102 using an import module 514.

Once the computer filed has been imported, a simulation module 516 may simulate the refined business process in the virtual world. In certain embodiments, the simulation module 516 may include a control module 530 to control the avatars of the various participants (e.g., by making them chat and/or interact) in order to show the refined actions and communications. These refined actions and communications may be used to educate participants in the business process or upper-level management as to how the refined business process would play out in real life without actually having to put the refined business process into practice. In this way, business processes can be iterative created, simulated, analyzed, and improved at low cost and without significant impact on the real word operations of the business.

The flowchart and block diagrams in the Figures illustrate the architecture, functionality, and operation of possible implementations of systems, processes, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

We claim:

1. A method for using a virtual world to iteratively refine a business process, the method comprising:
executing a virtual world server application on a computer processor;
loading a simulated work environment into the virtual world server application; the simulated work environment corresponds to a specific real-world work environment enabling a plurality of users to log into the virtual-world server application as study participants;
enabling the participants to act out a real-world business process in the virtual-world work environment;
capturing the actions and communications of the participants while acting out the real-world business process;
exporting captured actions into the business process modeling application, the business process modeling application displaying a business process containing the actions and communications; and
creating a refined business process by revising the business process in the business process modeling application.
replaying the refined business process in the simulated virtual world environment.

2. The method of claim 1, further comprising establishing a project in the virtual-world work environment corresponding to the real-world business process.

3. The method of claim 2, further comprising assigning the participants to the project.

4. The method of claim 1, further comprising importing the refined business process into the virtual-world work environment.

5. The method of claim 4, further comprising simulating the refined business process in the virtual-world work environment.

6. The method of claim 1, wherein the captured actions comprise at least one of the following: the actions performed by the participants; the participants that performed the actions; communications that occurred between the participants; the time and date the actions and communications occurred; and the locations where the actions and communications occurred.

7. An apparatus for using a virtual world to model a business process, the apparatus comprising:
a virtual world module to provide a virtual-world work environment corresponding to a real-world work environment;
a participation module to enable a plurality of users to log into the virtual-world work environment as participants;
the virtual world module further configured to enable the participants to act out a real-world business process in the virtual-world work environment;
a capture module to capture the actions and communications of the participants while acting out the real-world business process; and
a file-generation module to store the actions and communications in a computer file, the computer file being exportable into a business process modeling application.

8. The apparatus of claim 7, further comprising a setup module to establish a project in the virtual-world work environment corresponding to the real-world business process.

9. The apparatus of claim 8, further comprising an assignment module to assign the participants to the project.

10. The apparatus of claim 7, further comprising an export module to export the computer file into the business process modeling application, the business process modeling application displaying a business process comprising the actions and communications.

11. The apparatus of claim 10, wherein the business process modeling application is configured to enable a process analyst to generate a refined business process by revising the business process.

12. The apparatus of claim 11, further comprising an import module to import the refined business process into the virtual-world work environment.

13. The apparatus of claim 12, further comprising a simulation module to simulate the refined business process in the virtual-world work environment.

14. The apparatus of claim 7, wherein the computer file records at least one of the following: the actions performed by the participants; the participants that performed the actions; communications that occurred between the participants; the time and date the actions and communications occurred; and the locations where the actions and communications occurred.

15. A computer program product using a virtual world to model a business process, the computer program product comprising: a non-transient computer-readable medium having computer-readable program code embodied therein, the computer-readable program code comprising:
computer-readable program code to provide a virtual-world work environment corresponding to a real-world work environment;
computer-readable program code to enable a plurality of users to log into the virtual-world work environment as participants;
computer-readable program code to enable the participants to act out a real-world business process in the virtual-world work environment;
computer-readable program code to capture the actions and communications of the participants while acting out the real-world business process; and
computer-readable program code to store the actions and communications in a computer file, the computer file being exportable into a business process modeling application.

16. The computer program product of claim 15, further comprising computer-readable program code to establish a project in the virtual-world work environment corresponding to the real-world business process.

17. The computer program product of claim 16, further comprising computer-readable program code to assign the participants to the project.

18. The computer program product of claim 15, further comprising computer-readable program code to export the computer file into the business process modeling application, the business process modeling application displaying a business process containing the actions and communications.

19. The computer program product of claim 18, further comprising computer-readable program code to generate a refined business process by revising the business process.

20. The computer program product of claim 19, further comprising computer-readable program code to import the refined business process into the virtual-world work environment.

21. The computer program product of claim 20, further comprising computer-readable program code to simulate the refined business process in the virtual-world work environment.
